(19) United States
(12) Patent Application Publication
(10) Pub. No.: US 2014/0172239 A1
(43) Pub. Date: Jun. 19, 2014

(54) TURNING GUIDE ASSISTANT FOR TRAILER TOWING

(71) Applicant: CONTINENTAL AUTOMOTIVE SYSTEMS, INC., Auburn Hills, MI (US)

(72) Inventors: Jonathan Estrella Vergara, Tiaquepaque (MX); Victoria Elvira Arellano Echeverria, Zapopan (MX); David Marron Baez, Zapopan (MX)

(73) Assignee: CONTINENTAL AUTOMOTIVE SYSTEMS, INC., Auburn Hills, MI (US)

(21) Appl. No.: 13/713,501

(22) Filed: Dec. 13, 2012

(51) Int. Cl. G08G 1/16

(52) U.S. Cl. CPC G08G 1/167
USPC 701/49; 340/431

(57) ABSTRACT

A turning guide assistant system relates to automotive vehicles, and more particularly to advanced driver assistance systems and active safety systems for automotive vehicles. The turning guide assistant system provides a plurality of projected beams located along the vehicle. When a turning maneuver for the vehicle is performed the beams will clearly display the path of the vehicle on the road. The path will be easily visible to those proximate to the vehicle helping them to stay outside or move outside the path of the vehicle. The turning guide assistant system may include audio and visual alarms external to the vehicle for those in the proximity to reduce the number of accidents. Additionally, the system will alert and warn the driver of any objects detected in the vehicle path.

### TECHNICAL FIELD

The present disclosure relates to automotive vehicles, and more particularly to driver assistance systems and active safety systems for automotive vehicles.

### BACKGROUND

Mirrors are used to enhance the field of vision seen by a driver of a vehicle. The mirrors are used to allow the driver to view vehicles located behind and beside them. The mirrors are typically secured to the top-center of the windshield area and either side of the vehicle for convenience of the driver. However, the driver's vision is still obstructed at several locations by structural elements that cannot be removed from the vehicle, such as at “blind-spots” on either side of the vehicle that are out of range of the driver's direct vision and the mirrors in a standard mirror arrangement. For commercial trucks and vehicles with trailers the “blind-spot” is elongated.

When a vehicle turns the rear wheels follow a shorter path than the front wheels. This is commonly referred to as off track. The longer the vehicle wheel-base is, the shorter the path the rear wheels take during a turn. Therefore, due to the wheel-base length of commercial trucks the turning radius of the trailer, following the vehicle, is decreased. To compensate for the short turning path the vehicles must make wider turns. In city environments the area available for vehicles to turn is reduced. Thus, buildings, pedestrians and other vehicles in the proximity of the truck may be in danger of impact with the vehicle during the turn and may additionally be located in the vehicle blind-spot during the turn.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A turning guide assistant system provides a plurality of projected beams located along the vehicle. When a turning maneuver for the vehicle is performed the projected beams will clearly display the path of the vehicle on the road. The path will be easily visible to those proximate to the vehicle helping them to stay outside or move outside the path of the vehicle. The turning guide assistant system may include audio and visual alarms external to the vehicle for those in the proximity to reduce the number of accidents. Additionally, the system will alert and warn the driver of any objects detected in the vehicle path.

A driver assistance system for a vehicle comprises a plurality of projection devices rotatably mounted to the vehicle capable of projecting a beam visible to those proximate to the vehicle. An electronic control unit is controllably connected to plurality of projection devices to control the position of the plurality of projection devices based upon a steering angle of the vehicle and to display a vehicle path with at least one of the plurality of projection devices when the electronic control unit determines the vehicle is executing a turning maneuver. A plurality of sensors are mounted to the vehicle to detect an object in an area proximate to the vehicle. The plurality of sensors are connected to the electronic control unit and the electronic control unit determines when an object is in one of a plurality of protection zones. The electronic control unit activates a warning device for at least an operator of the vehicle based upon the one of the plurality of protection zones in which the object is detected.

A method of assisting a vehicle in turning comprises detecting when a vehicle is performing a turning maneuver and displaying a projected beam from a projection device along a predicted vehicle path during the turn. An object is detected in one of a plurality of protection zones proximate to the vehicle and one of a plurality of warnings is provided to at least an operator of the vehicle based upon which of the plurality of protection zones the object is detected in.

A driver assistance system for a vehicle comprises an electronic control unit, which contains instructions for detecting when the vehicle is performing a turning maneuver. The ECU also has instructions for displaying a projected beam from a projection device along a predicted vehicle path during the turn, detecting an object in one of a plurality of protection zones proximate to the vehicle, and providing one of a plurality of warnings to at least an operator of the vehicle based upon which of the plurality of protection zones the object is detected in.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a top-view of a commercial vehicle utilizing a turning guide assistant system of the present invention;

FIG. 2 is a schematic illustration of a top-view of a commercial vehicle utilizing a turning guide assistant system of FIG. 1 during a right-turn; and

FIG. 3 is a schematic illustration of an arrangement and method for using the turning guide assistant system of the present invention.

### DETAILED DESCRIPTION

The following description is merely exemplary in nature and is in no way intended to limit the disclosure, its application, or uses. For purposes of clarity, the same reference numbers will be used in the drawings to identify similar elements. Throughout the application the relative directions such as forward and rear are in reference to the direction which a driver for the vehicle 10 would primarily be facing when operating the vehicle 10.

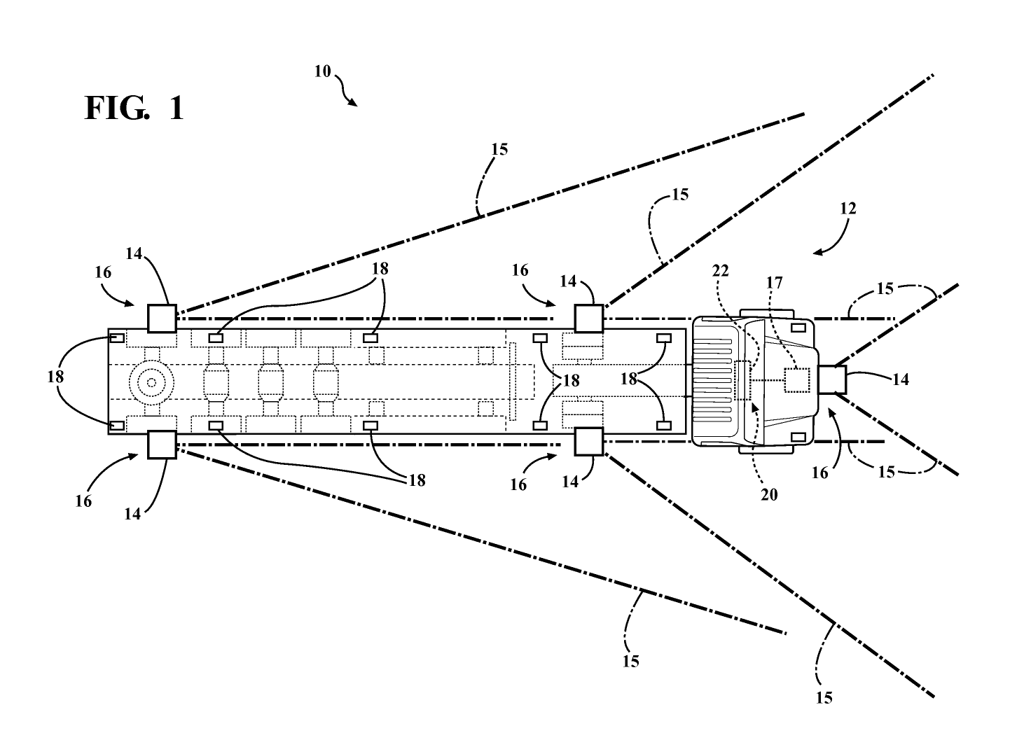

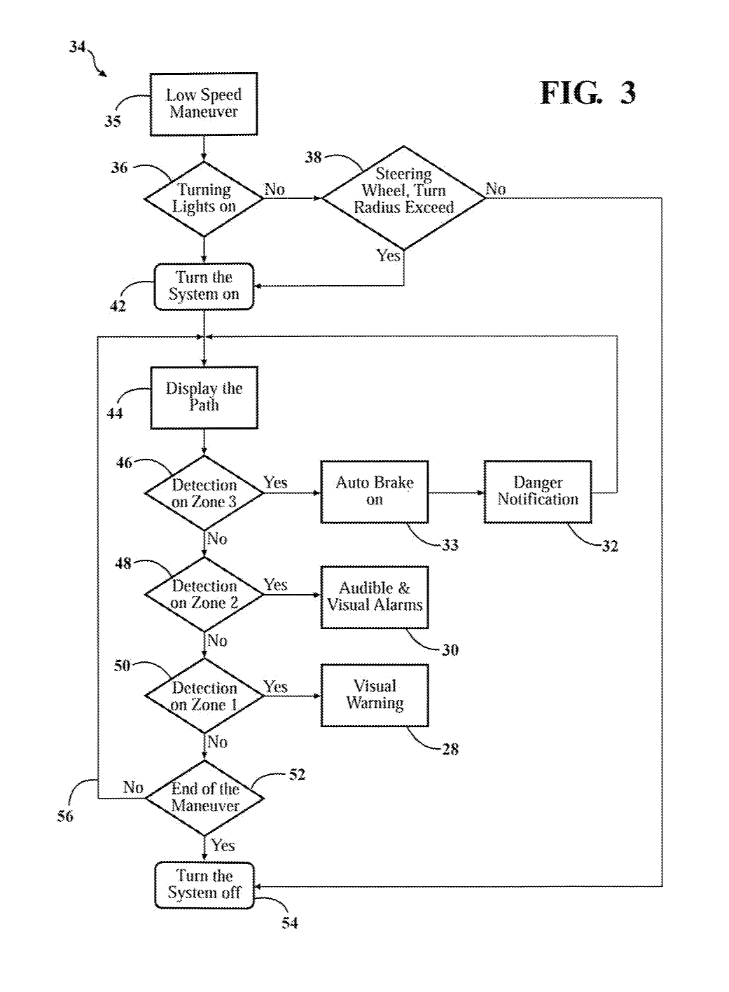

FIG. 1 thru FIG. 3 illustrates a vehicle 10 and a turning guide assistant system 12 of the present invention. The turning guide assistant system 12 displays the turning path of the vehicle 10 to those in proximity to the vehicle 10. The turning guide assistant system 12 includes a plurality of projection devices 14 mounted to a plurality mounting locations 16 on the vehicle 10. In the embodiment shown, the mounting locations 16 are the front of the vehicle 10, and the front and rear axle of the trailer on either side of the vehicle 10. Each of the projection devices 14 have an initial projection position as illustrated. The projection devices 14 emit a projected beam 15 visible to people that are proximate to the vehicle 10. For example, the projected beam 15 may be a light beam or holographic laser projection from displaying an image on the road

The turning guide assistant system 12 may be fitted to any car and trailer assembly, to a commercial vehicle with or without a separate trailer, or to a vehicle with an extended length wheel-base. The turning guide assistant system 12 provides a plurality of projected beams 15 located along the vehicle 10. When a turning maneuver is performed the projected beams 15 will clearly display the path of the vehicle 10 on the road. The path will be easily visible to those proximate to the vehicle 10 helping them to stay outside or move outside the path of the vehicle 10. The turning guide assistant system 12 may include audio and visual alarms external to the vehicle 10 for those in the proximity to reduce the number of accidents. Additionally, the system 12 will alert and warn the driver of any objects 26 detected in the vehicle 10 path, as explained in further detail below.

The projection devices 14 are connected to an electronic control unit 17. The ECU 17 at least controls the movements of the projection devices 14, determines the predicted vehicle 10 path, and processes information from a plurality of sensors 18. The turning guide assistant system 12 may be used to assist vehicle 10 operators when performing low speed maneuvers.

The turning guide assistant system 12 may be initiated when the vehicle 10 begins a turn. The turn may be detected by a turn signal indicator and/or a steering wheel angle of the vehicle 10. For example, when the steering wheel angle is above a predetermined threshold, e.g. the steering wheel is turned greater than to a one o'clock position or to an 11 o'clock position, the turning guide assistant system 12 is activated.

The turning guide assistant system 12 may have warning devices 20. The warning devices 20 may include external warning devices for the pedestrians or occupants of other vehicles and has internal warning devices for the operator of the vehicle 10. The internal warning devices include audible, visual, and haptic warning devices. The turning guide assistant system 12 may also include a display 22 which the vehicle 10 operator may see.

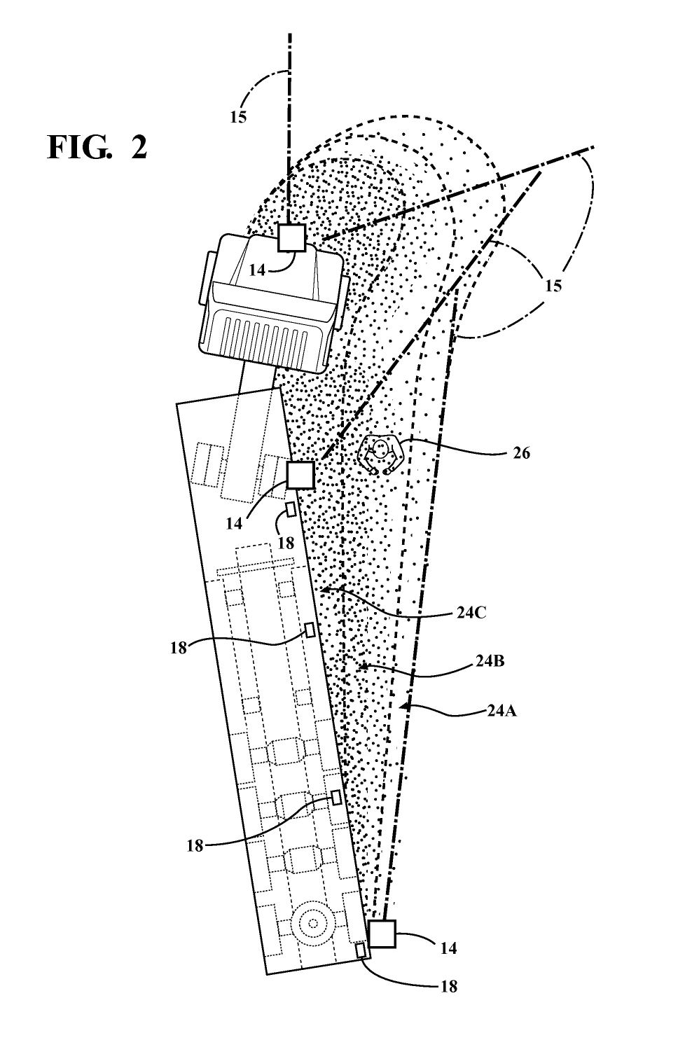

When the vehicle 10 starts a turn, as illustrated in FIG. 2, the turning guide assistant system 12 defines multiple zones of protection 24A-C based upon the steering angle of the front vehicle wheels. Although a right hand turn is illustrated, the turning guide assistant system 12 may apply to turns in either direction, or when backing the vehicle 10. The display 22 may show an image such as that depicted in FIG. 2.

The projection devices 14 rotate from their original positions to another position to indicate the expected vehicle 10 position throughout the turn. The projection devices 14 may be mounted at the various mounting locations 16 on a rotatable base. The projection devices 14 are rotate on their individual bases to the desired angle for that projection device by the ECU 17. The ECU 17 determines the amount of rotation of each projection device 14 based upon the steering angle of the vehicle 10 and the mounting location 16 for that projection device 14. Therefore, the projected beam 15 from each of the projection devices 14 moves based upon the steering angle of the vehicle 10. The projected beam 15 indicates to people that are proximate to the vehicle 10 what the expected path of the vehicle 10 will be throughout the turn. The projected beam 15 may also be shown on the display 22 to the operator of the vehicle 10.

The object 26 may be detected by the turning guide assistant system 12 using a plurality of sensors 18. The plurality of sensors 18 may be any type of sensor capable of detecting an object proximity to the vehicle 10, e.g. ultrasonic, infrared sensors, or pedestrian detection cameras. The turning guide assistant system 12 may categorize the area proximate to the vehicle 10 into the plurality of protection zones 24A-C. In the embodiment shown, there are three protection zones 24A-C. Greater or fewer protection zones 24A-C may be defined by the system 12.

In the embodiment shown, the first protection zone 24A is an area where contact with an object 26 is not very likely. Notice of the turn should be provided but there is time and space to move or correct the steering of the vehicle 10 to prevent contact. The second protection zone 24B is located closer to the vehicle 10. There is less time to avoid contact by moving or correcting the steering of the vehicle 10 and an increased warning should be given to avoid contact with the object 26. In the third protection zone 24C contact with the object 26 is imminent. Corrective and avoidance actions should be initiated immediately to avoid contact with the object 26.

In the first zone, 24A the object 26, such as a pedestrian or a building is not likely in the projected path of the vehicle 10 and the object 26 is safe. If the display 22 is available in color the first zone 24A may be depicted in a green color to indicate that contact with the object 26 is not expected based upon the predicted vehicle 10 path. A first warning 28 may be given to indicate there is an object 26 close to the vehicle 10, but not likely to make contact with the vehicle 10. The first warning 28 may be given using the warning devices 20. The first warning 28 may simply be the projected beam 15 from the projection devices 14 as an external warning and an audio signal initiated by the ECU 17 or a visual signal to the on the display 22. For example, the visual signal may be a lighted warning lamp or highlighting the appropriate zone 24A-C on the display 22 and marking the detected location of the object 26. Additionally, the different zones may be displayed externally by changing the color of the beam 15 emitted from the projection device 14 such that the projected beams 15 show the different protection zones 24A-C.

In a second zone 24B, the object 26 is within the vehicle path and contact may occur. An avoidance action by the object 26 and/or the operator of the vehicle 10 would be suggested to ensure that contact does not occur. On the display 22 the second zone 24B would be depicted as yellow. A second warning 30 using the warning devices 20 is given by the turning guide assistant system 12. The second warning 30 may be increased over the first warning 28 to provide greater notification to the driver and those proximate to the vehicle 10. For example, the driver's warning may be both audio and visual and/or the audio warning may be louder or of increasing volume as the object 26 is approached. The visual warning may include highlighting the appropriate zone 24A-C on the display 22, flashing the lighted display and marking the detect location of the object 26, flashing a warning lamp and sounding a tone, etc.

In a third zone 24C, the object 26 is within the vehicle path and contact will definitely occur unless immediate action is taken. An avoidance action by the object 26 and/or the operator of the vehicle 10 is required to ensure that contact does not occur. On the display 22 the third zone 24C would be depicted as red. A third warning 32 using the external and/or an internal warning device(s) 20 is given by the turning guide assistant system 12. The third warning 32 has increased noticeability to the driver and those proximate to the vehicle 10 over the second warning 30. For example, the driver's warning may be audio, visual, and haptic, e.g. a steering wheel or gas pedal vibration, and/or the audio warning may be louder or of increasing volume as the object 26 is approached. The visual warning may include highlighting the appropriate zone 24A-C on the display 22, flashing the lighted display and marking the detect location of the object 26, flashing a warning lamp and sounding a tone, etc. Additionally, the vehicle brakes 33 may automatically be applied by the turning guide assistant system 12.

Referring to FIGS. 1 through 3, which illustrate the turning guide assistant system 12 one method and arrangement for operating the turning guide assistant system 12 is illustrated at 34. Maneuvering of the vehicle 10 through a path having many obstacles typically is done at low speeds to provide drivers with the time to manipulate the vehicle 10. Therefore, the turning guide assistant system 12 may be used to assist the vehicle 10 in low speed maneuvering. The turning guide assistant system 12 may be initiated when the vehicle 10 is below a predetermined speed threshold, e.g. less than 25 mph. Additionally, the turning guide assistant system 12 is primarily used to assist the operator of the vehicle 10 during turning operations. Therefore, the system 12 may alternatively initiate when a turn is sensed by the system 12. The turning guide assistant system 12 may detect a turn when indicated with a turn signal indicator, shown at 36. However, even if the operator fails to indicate a turn the turning guide assistant system 12 may detect a turn is occurring based upon the steering wheel angle and initiate the system 12 anyway, shown at 38. If the turn indicator is not on and the steering angle does not indicate a turn the system 12 will turn off, shown at 54.

If a turn is detected the turning guide assistant system 12 continues to operate, shown at 42. Each of the projection devices 14 on the appropriate side of the vehicle 10 is moved to the proper position to display the vehicle turning path by rotating on the projection devices 14 on the bases, shown at 44. As the vehicle 10 is steered through a turn the ECU 17 calculates and determines the steering angle and moves the projection devices 14 to new positions to show these changes. The ECU 17 also shows the path by showing the zones 24A-C on the display 20.

When an object is detected the ECU 17 analysis the data to determine if the object 26 is in the third zones 24C, shown at 46. If the object 26 is in the third zone 24C the turning guide assistant system 12 issues the third warning 32 to the driver and those proximate to the vehicle 10. The turning guide assistant system 12 may also automatically apply the vehicle brakes, shown at 33. If the object is not in the third zone 24C the ECU 17 determines whether the object is in the second zone 24B. If the object 26 is in the second zone 24B the turning guide assistant system 12 issues the second warning 30 to the driver and those proximate to the vehicle 10. If the object is not in the second zone 24B the ECU 17 determines whether the object is in the first zone 24A. If the object 26 is in the first zone 24A the turning guide assistant system 12 issues the first warning 28 to the driver and those proximate to the vehicle 10.

The ECU 17 detects when the maneuver is complete, e.g. the ECU 17 detects when the steering wheel angle is less than the threshold, shown at 52. If the maneuver is complete the turning guide assistant system 12 is turned off until the next low speed maneuver begins, shown at 54. However, if the maneuver is not complete the turning guide assistant system 12 continues to operate. As the vehicle 10 moves through the turn the ECU 17 continues to monitor the protection zones 24A-C. If an object 26 moves from one zone to another, closer to the vehicle 10 the movement will be detected by the turning guide assistant system 12, shown at 56.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A driver assistance system for a vehicle comprising:
a plurality of projection devices rotatably mounted to the vehicle capable of projecting a beam visible to those proximate to the vehicle;
an electronic control unit controllably connected to plurality of projection devices to control the position of the plurality of projection devices based upon a steering angle of the vehicle and to display a vehicle path with at least one of the plurality of projection devices when the electronic control unit determines the vehicle is executing a turning maneuver;
a plurality of sensors mounted to the vehicle to detect an object in an area proximate to the vehicle, wherein the plurality of sensors are connected to the electronic control unit;
wherein the electronic control unit determines when an object is in one of a plurality of protection zones; and
wherein electronic control unit activates a warning device for at least an operator of the vehicle based upon the one of the plurality of protection zones in which the object is detected.

2. The driver assistance system of claim 1, further comprising:
a first warning signal is sent to the vehicle operator when the object is in a first of the plurality of protection zones, wherein the first warning signal is one of an audio signal, a visual signal and a haptic signal;
a second warning signal is sent to the vehicle operator when the object is in a second of the plurality of protections zone, wherein the second warning signal is at least two of an audio signal, a visual signal and a haptic signal; and
a third warning signal is sent to the vehicle operator when the object is in a third of the plurality of protections zone, wherein the third warning signal is at least three of an audio signal, a visual signal, a haptic signal and an application of the vehicle brakes.

3. The driver assistance system of claim 1, wherein the plurality of mounting positions include at least one of: a front of the vehicle, a right side of a front axle of a trailer for the vehicle, a left side of the front axle, a right side of a rear axle of the trailer and a left side of the rear axle.

4. The driver assistance system of claim 1, wherein the plurality of sensors is one of: ultrasonic sensors, infrared sensors, and object detection cameras.

5. The driver assistance system of claim 1, further comprising a display screen connected to the electronic control unit, wherein the electronic control unit shows the multiple zones of protection on the display screen.

6. The display system of claim 1, wherein the object is shown on the display screen relative to the position of the vehicle.

7. A method of assisting a vehicle in turning comprising:
detecting when a vehicle is performing a turning maneuver;
displaying a projected beam from a projection device along a predicted vehicle path during the turn;
detecting an object in one of a plurality of protection zones proximate to the vehicle; and
providing one of a plurality of warnings to at least an operator of the vehicle based upon which of the plurality of protection zones the object is detected in.

8. The method of claim 7, wherein the electronic control unit further comprises checking if a vehicle speed is below a predetermined speed threshold.

9. The method of claim 7, wherein detecting when the vehicle is performing a turning maneuver further comprises one of detecting a turn indicator is being used and detecting a steering angle of the vehicle is above a predetermined threshold.

10. The method of claim 7, wherein displaying the projected beam along the predicted vehicle path further comprises rotating the projection device to a position which will emit the projected beam along the predicted path of the vehicle.

11. The method of claim 7, further comprising
providing a first warning signal to the vehicle operator when the object is in a first of the plurality of protection zones, wherein the first warning signal is one of an audio signal, a visual signal and a haptic signal;
providing a second warning signal to the vehicle operator when the object is in a second of the plurality of protections zone, wherein the second warning signal is at least two of an audio signal, a visual signal and a haptic signal; and
providing a third warning signal to the vehicle operator when the object is in a third of the plurality of protections zone, wherein the third warning signal is at least three of an audio signal, a visual signal, a haptic signal and an application of the vehicle brakes.

12. A driver assistance system for a vehicle comprising:
an electronic control unit, wherein the electronic control unit contains instructions for:
detecting when a vehicle is performing a turning maneuver;
displaying a projected beam from a projection device along a predicted vehicle path during the turn;
detecting an object in one of a plurality of protection zones proximate to the vehicle; and
providing one of a plurality of warnings to at least an operator of the vehicle based upon which of the plurality of protection zones the object is detected in.

13. The driver assistance system of claim 12, further comprising a plurality of projection devices rotatably mountable to the vehicle capable of projecting a beam visible to those proximate to the vehicle.

14. The driver assistance system of claim 13, wherein the electronic control unit contains further instructions for controlling the position of the plurality of projection devices based upon a steering angle of the vehicle.

15. The driver assistance system of claim 13, wherein a plurality of mounting positions for the plurality of projection devices include at least one of: a front of the vehicle, a right side of a front axle of a trailer for the vehicle, a left side of the front axle, a right side of a rear axle of the trailer and a left side of the rear axle.

16. The driver assistance system of claim 12, further comprising a plurality of sensors mountable to the vehicle to detect an object in an area proximate to the vehicle, wherein the plurality of sensors are connected to the electronic control unit.

17. The driver assistance system of claim 16, wherein the plurality of sensors is one of: ultrasonic sensors, infrared sensors, and object detection cameras.

18. The driver assistance system of claim 12, wherein the electronic control unit contains further instructions for:
providing a first warning signal to the vehicle operator when the object is in a first of the plurality of protection zones, wherein the first warning signal is one of an audio signal, a visual signal and a haptic signal;
providing a second warning signal to the vehicle operator when the object is in a second of the plurality of protections zone, wherein the second warning signal is at least two of an audio signal, a visual signal and a haptic signal; and
providing a third warning signal to the vehicle operator when the object is in a third of the plurality of protections zone, wherein the third warning signal is at least three of an audio signal, a visual signal, a haptic signal and an application of the vehicle brakes.

19. The driver assistance system of claim 18, further comprising a display screen connected to the electronic control unit, wherein the electronic control unit contains instructions for showing the multiple zones of protection on the display screen.

20. The display system of claim 18, wherein the object is shown on the display screen relative to the position of the vehicle.
